(19) United States
(12) Patent Application Publication
(10) Pub. No.: US 2010/0174440 A1
(43) Pub. Date: Jul. 8, 2010

(54) Driving Assistance Method and Device for a Vehicle for Travelling Along a Predetermined Path Between a First Point and a Second Point

(76) Inventors: Jean-Laurent Franchineau, Paris (FR); Emmanuel De Verdalle, Paris (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/601,600

(22) PCT Filed: May 26, 2008
(86) PCT No.: PCT/FR08/50905

§ 371 Date: Nov. 24, 2009

(30) Foreign Application Priority Data
May 30, 2007 (FR) 0755329
Jun. 27, 2007 (FR) 0756076

(51) Int. Cl. G06F 7/00; G01C 21/00

(52) U.S. Cl. 701/29

(57) ABSTRACT

The invention relates to a driving assistance device (100) for a vehicle that is to travel along a defined run between a first point and a second point. The invention is characterized by the fact that the assistance device comprises generator means for generating a curve of optimum driving profiles seeking to optimize the energy consumed by the vehicle in order to travel along the run and to optimize the time taken to travel along the run, means (180) for determining a current driving profile at a current position of the vehicle, means (220) for determining an optimum driving profile for the current position from the curve of optimum profiles, a comparator (300) for determining a difference between the current driving profile and the optimum driving profile for the current position, and means (320) for correcting the driving profile of the vehicle as a function of the difference (εt)) as determined.

The present invention relates to the field of providing driving assistance for a vehicle, e.g. a train, a car, a bus, a tram, or any other land vehicle.

More precisely, the invention relates to a method of assisting the driving of a vehicle that is to travel along a run defined between a first point and a second point.

Traditionally, methods of assisting in the driving of a vehicle serve to provide the driver with the geographical location of the vehicle, its speed, and also the positions of remarkable points such as, for example, bends or junctions. Document EP 1 605 233 describes a system suitable for implementing such a method.

Document U.S. Pat. No. 6,092,021 also discloses a method of assisting the driving of a vehicle, which method enables driving conditions to be detected that will lead to excess energy consumption, on the basis of the speed of the vehicle, an estimate of the weight of the vehicle, or of its acceleration.

Document U.S. Pat. No. 5,627,752 disclosed a method of limiting vehicle speed as a function of the distance that remains to be traveled and of the available energy.

Nevertheless, known methods do not make it possible to optimize the energy consumed by the vehicle in order to travel along the run and the time taken to travel along said run.

An object of the present invention is to provide a driving assistance method that remedies the above-mentioned drawbacks.

This object is achieved by the fact that there is provided a curve of optimum driving profiles seeking to optimize the energy consumed by the vehicle in order to travel along the run and the time taken to travel along the run, in which method, while the vehicle is traveling, the following steps are performed: determining a current driving profile at a current position of the vehicle; determining an optimum driving profile for the current position from the curve of optimum profiles; determining a difference between the current driving profile and the optimum driving profile for the current position; and correcting the driving profile of the vehicle as a function of the difference as determined.

In the meaning of the present invention, the curve of optimum driving profiles is made up of a set of optimum driving profiles. This curve is preferably contained in a database.

Preferably, each of the optimum driving profiles of the curve is associated with a position along the run.

Furthermore, each of the optimum driving profiles comprises a plurality of optimum values for magnitudes characteristic of the driving of the vehicle, such as, for example, but not exclusively: the optimum speed and acceleration; the engine speed; and the fuel consumption of the vehicle for the position associated with said optimum driving profile.

Furthermore, the current driving profile for the current position of the vehicle comprises a plurality of current values for the above-mentioned magnitudes characteristic of the driving of the vehicle.

Thus, when a difference between the current driving profile and the optimum driving profile for a given current position is detected, action is taken on the vehicle controls to correct the driving profile of the vehicle so as to cause the current values of the characteristic magnitudes to approach their optimum values so as to correspond once more to the optimum driving profile, or at least so as to tend towards said profile. In this way, the energy consumed by the vehicle and the time taken by the vehicle to travel along the run are optimized.

Furthermore, the curve of optimum driving profiles can be generated by weighting optimization criteria comprising the energy consumption of the vehicle and the time taken to travel along the run.

Preferably, but not exclusively, the time taken to travel along the run is a predetermined duration, such that the above-mentioned optimization amounts to minimizing the energy consumed in order to travel along the run within the predetermined duration.

Preferably, the run is constituted by a plurality of stopping points.

Advantageously, the curve of optimum driving profiles is determined from a digital map of the run, which map preferably comprises the latitude, the longitude, and the altitude of the plurality of points making up the run, preferably together with the curvature of the run, its cant, and/or its slope.

Preferably, the first and second above-mentioned points are two points taken from the plurality of points making up the run.

Preferably, the first and second points constitute stopping points for the vehicle.

The term “stopping point” is used for example to mean a station where the vehicle stops if the vehicle needs to stop frequently at determined locations, as applies for example to a bus, to a tram, to a delivery or pickup vehicle, or else a traffic light, or a pedestrian crossing, or any other untimely or occasional stop.

Preferably, the vehicle run comprises a plurality of stopping points and a new curve of optimum driving profiles is determined at each stopping point of the vehicle, the new curve being determined between the above-mentioned stopping point and the next expected stopping point.

Advantageously, the curve of optimum driving profiles is also determined from the positions of objects having coordinates that are contained in the digital map of the run.

By way of example, these objects may be a pedestrian crossing, a traffic light, and/or a stop panel, of positions along the run that are known.

In the particular circumstance where provision is made for the vehicle to arrive at the second point at a particular time, the curve of optimum driving profiles is also advantageously determined on the basis of the extent to which the vehicle is early or late compared with the intended time of arrival at the second point.

One advantage is to take account of the constraint associated with the expected time of arrival at the second point when determining the curve of optimum driving profiles. For example, it may be decided that lateness should be caught up in full or in part to the detriment of energy consumption. Conversely, it may be decided to cause the vehicle to loose time so as to limit energy consumption to a greater extent in the event that the vehicle is found to be early compared with the expected time of arrival at the second point.

Advantageously, the current driving profile is determined from parameters intrinsic to the vehicle at the current position, said intrinsic parameters comprising at least one magnitude selected from fuel consumption, engine speed, vehicle speed, engine torque, and acceleration of the vehicle at the current position.

Preferably, the intrinsic parameters are determined from a multiplexed databus of the vehicle, the databus being of the controller area network (CAN) type.

Advantageously, the current position of the vehicle is detected.

Preferably, the current position of the vehicle is detected by a global positioning system such as for example GPS, GALILEO, or beacons on the ground, that provide the coordinates of the vehicle.

In the meaning of the invention, the current position of the vehicle corresponds to its geographical location at the current instant.

In particularly advantageous manner, the optimum driving profile for the current position is also determined while taking account of the mass of the vehicle at the current position.

This vehicle mass is preferably updated in real time as the vehicle travels so as to take account of possible variations in the vehicle load, which variations may be due for example to people embarking or disembarking along the run, or indeed to objects being loaded onto or off the vehicle.

Preferably, the mass of the vehicle is determined from sensors, e.g. disposed in the vehicle suspension, or from a device for counting or identifying people or objects.

Advantageously, the optimum driving profile for the current position is also determined as a function of the presence of obstacles on the run as determined by telemetry or by one or more distance measuring means.

For this purpose, it is preferable to use a telemeter, such as a radar or a laser for example, in order to detect any obstacle(s).

The term “obstacle” is used to mean an object of existence and position that were not expected prior to being detected by the above-mentioned distance measurement means. By way of example, such an obstacle may be another vehicle stopped on the roadway, a pedestrian, or any other type of obstacle that might impede the mobility of the vehicle.

Advantageously, the optimum driving profile for the current position is also determined as a function of the use of auxiliary equipment such as for example: an air conditioning system, an air compressor, or an alternator.

Advantageously, there is provided a new curve of optimum driving profiles between the current position of the vehicle and the second point if the difference determined at the current position is greater than a predetermined threshold.

An advantage is to take account of a situation in which the vehicle slows down excessively, e.g. because of a detected obstacle or because of a traffic light changing to red.

Preferably, the new curve of optimum driving profiles is calculated from parameters intrinsic to the vehicle at the current position, said intrinsic parameters comprising at least one magnitude selected from fuel consumption, engine speed, vehicle speed, engine torque, and vehicle acceleration at the current position.

In an advantageous variant, the difference as determined is sent to a man-machine interface so as to provide the driver of the vehicle with a signal representative of the difference.

Thus, the man-machine interface provides information to the driver of the vehicle, preferably visual information, relating to the action that needs to be taken on the vehicle controls in order to correct the driving profile.

The present invention also provides a driving assisting device for a vehicle that is to travel along a defined run between a first point and a second point, the device comprising generator means for generating a curve of optimum driving profiles seeking to optimize the energy consumed by the vehicle in order to travel along the run and to optimize the time taken to travel along the run, means for determining a current driving profile at a current position of the vehicle, means for determining an optimum driving profile for the current position from the curve of optimum profiles, a comparator for determining a difference between the current driving profile and the optimum driving profile for the current position, and means for correcting the driving profile of the vehicle as a function of the difference as determined.

The generator means for generating a curve of optimum driving profiles advantageously include a digital map of the run.

The digital map contains the three-dimensional coordinates of a plurality of points making up the run, and also preferably the curvature, the cant, and the slope of the run.

Preferably, the generator means also contain a dynamic model of the vehicle. For each position of the vehicle, the dynamic model gives the behavior of the vehicle and in particular its energy consumption. Thus, the curve of optimum driving profiles is preferably generated from the dynamic model and from the digital map of the run, in such a manner as to minimize the energy consumed for traveling along the run in the predetermined duration.

Advantageously, the means for determining the current driving profile are suitable for acquiring parameters intrinsic to the vehicle at the current position, said intrinsic parameters comprising at least one magnitude selected from fuel consumption, engine speed, and the speed and acceleration of the vehicle at the current position.

Advantageously, the device of the invention further comprises a detector device for determining the current position of the vehicle.

Advantageously, the means for determining the optimum driving profiles for the current position further comprise distance measuring means for detecting the presence of obstacles on the run.

Advantageously, the device of the invention further comprises updating means for calculating a new curve of optimum driving profiles between the current position of the vehicle and the second point if the difference is greater than a predetermined threshold.

Preferably, the updating means are suitable for acquiring parameters intrinsic to the vehicle at the current position, said intrinsic parameters comprising at least one magnitude selected from fuel consumption, engine speed, and the speed and acceleration of the vehicle at the current position.

The invention will be better understood and its advantages will appear more clearly on reading the following detailed description of an embodiment given by way of non-limiting example. The description refers to the accompanying drawings, in which:

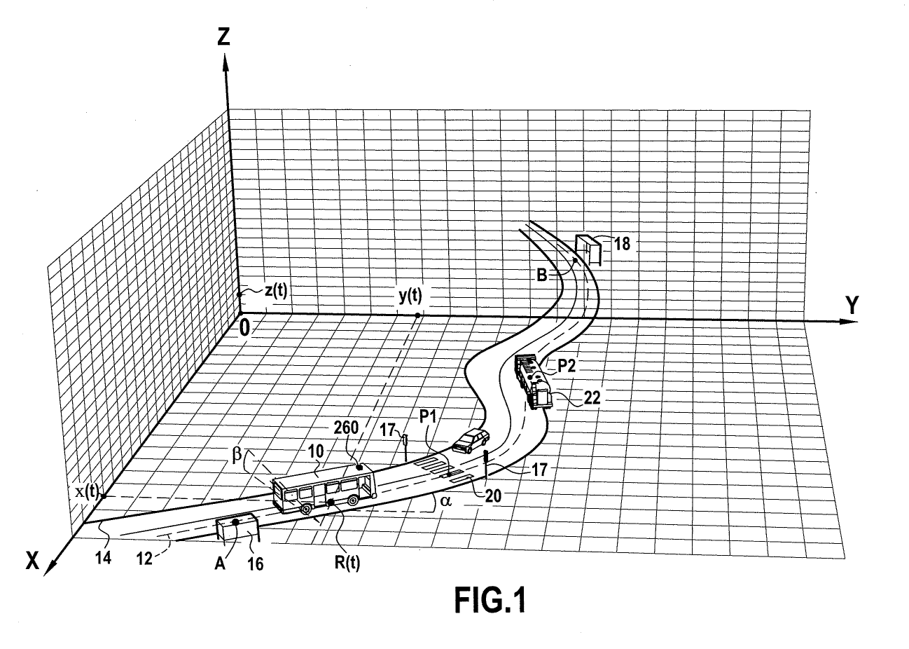

FIG. 1 shows the run that is to be followed by a vehicle including a driving assistance device of the present invention; and

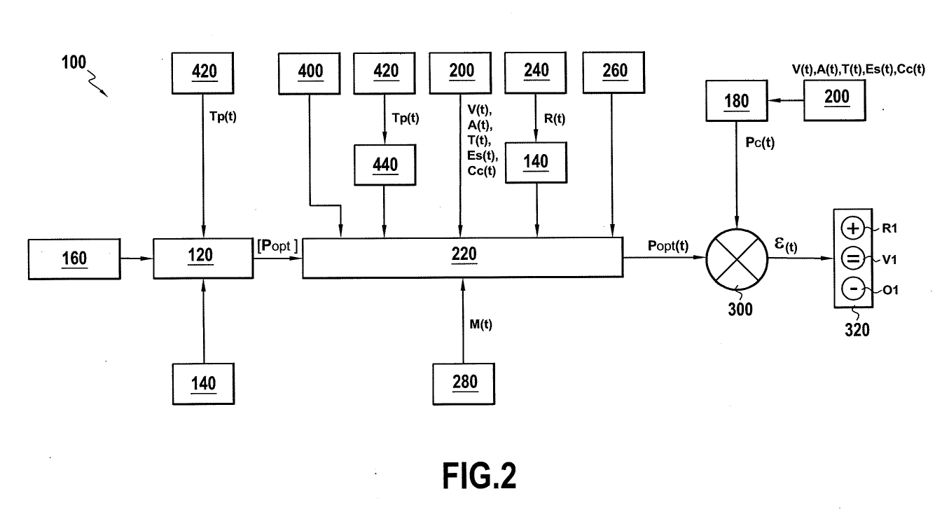

FIG. 2 is a diagram of the driving assistance device of the present invention.

With reference to FIGS. 1 and 2, there follows a description of a preferred implementation of the method in accordance with the present invention for providing driving assistance.

According to the invention, assistance is provided in the driving of a vehicle that, in the non-limiting example shown in FIG. 1, is constituted by a city bus 10. Without going beyond the ambit of the present invention, the driving assistance method may be applied to other types of vehicle, such as for example a train, a tram, a trolley bus, or any other type of vehicle.

The bus 10 shown in FIG. 1 is intended to follow a run 12 along a road 14, which run 12 is represented by a dashed-line curve. Naturally, the run 12 shown here is for understanding the invention and is not limiting in any way.

As can be seen in FIG. 1, the run 12 extends in a three-dimensional space defined by a frame of reference “0xyz”.

Specifically, the run 12 is defined between a first point A and a second point B, each of these points corresponding in this example to the position of a respective shelter 16 or 18. These are thus stopping points for the bus, it being understood that the points could equally well be constituted by points that are not stopping points without thereby going beyond the ambit of the present invention. Naturally, the run could also have more than two stopping points.

Preferably, the bus 10 is supposed to reach the first and second points A and B at predetermined times, and as a result of that the time taken by the bus 10 to travel along the run 12, and in the absence of any unexpected earliness or lateness, is equal to the difference between the time of arrival at the second point B and the time of departure from the first point A.

In a variant, times are replaced by durations on the run or by predetermined frequencies of passage.

As can be seen in FIG. 1, the run 12 extends in a three-dimensional space represented by the “0xyz” frame of reference, such that each of the points on the run presents a set of longitude, latitude, and altitude coordinates in the above-mentioned frame of reference, or indeed a slope α and a cant β. The slope a corresponds to the angle between a tangent to the run at the point under consideration taken relative to the altitude z, and the horizontal plane x0y, while the cant β corresponds to the transverse angle of inclination of the run at the point under consideration.

The current position of the bus 10 on the run 12 is referenced R(t) where t is the current instant. In other words, at the current instant t, the bus is at the current point R(t), which position presents coordinates x(t), y(t), and z(t) in the above-mentioned frame of reference, or indeed α(t) and β(t).

In particularly advantageous manner, the bus 10 includes a driving assistance device 100 in accordance with the present invention, as shown diagrammatically in FIG. 2.

This driving assistance device 100 has generator means 120 for generating a curve [Popt] of optimum driving profiles seeking to optimize the energy consumed by the bus in order to travel along the run 12 and in order to optimize the time taken to travel along the run 12.

Specifically, since the time taken to travel along the run 12 is known at the time said curve is generated, it results that the curve of the optimum driving profiles seeks to minimize the energy consumed by the bus in order to travel along the run 12 in the above-specified time.

More precisely, the curve of the optimum driving profile [Popt] is a continuous or discrete set of optimum driving profiles in which each of the optimum driving profiles Popt(Rᵢ) is a function of a point Rᵢ of the run 12. Specifically, the run 12 is constituted by N points Rᵢ such that the curve [Popt] can be written in the following form:

[Popt]=[Popt(R₁), Popt(R₂), . . . , Popt(R_{N})]

In the meaning of the invention, a driving profile is constituted by one or more values for magnitudes that are characteristic of driving the bus, such as speed V, acceleration A, engine torque T, engine speed Es, fuel consumption Cc, or any other characteristic magnitude.

In this example, the description is limited to three magnitudes, it being understood that it is also possible to select only the speed V, or indeed to take account of some larger number of magnitudes, depending on the desired accuracy.

In other words, the driving profile for the bus 10 at the point Rᵢ on the run 12 is constituted, for example, by the set comprising the speed V(Rᵢ) of the bus at the point Rᵢ, the acceleration A(Rᵢ) of the bus at the point Rᵢ, and the engine torque T(Rᵢ), the engine speed Es (Rᵢ)and the fuel consumption Cc(Rᵢ) at the point Rᵢ.

It can thus be understood that the current driving profile Pc(t) of the bus 10 at the current position R(t) is the set constituted by the set V(t) of the bus at the point R(t), the acceleration A(t) of the bus at the point R(t), the engine torque T(t), and also the engine speed Es(t) and the fuel consumption Cc(t) at the point R(t). It is thus possible to write:

Pc(t)=[V(t), A(t), T(t), Es(t), Cc(t)]

In addition, the optimum driving profile Popt(Rᵢ) at the point Rᵢ of the run 12 is the driving profile that the bus 10 is to present when it is situated at the point Rᵢ so that the energy consumed by the bus over the entire journey along the run 12 is a minimum, for given time taken to travel along the run.

In other words, the optimum profile comprises the optimum speed Vopt(Rᵢ), the optimum acceleration Aopt(Rᵢ), the optimum engine torque Topt(Rᵢ), the optimum engine speed Esopt(Rᵢ), and the optimum fuel consumption Ccopt(Rᵢ).

Thus, in the present example, the following can be written:

Popt(Rᵢ)=[Vopt(Rᵢ), Aopt(Rᵢ), Topt(R₁), Esopt(Rᵢ), Ccopt(R₁)]

Preferably, the curve of the optimum driving profiles is stored in a database of the assistance device 100.

Advantageously, the generator means 120 use a digital map 140 of the run 12, this digital map being preferably stored in a database.

The digital map 140 contains the coordinates of the points Rᵢ, i.e. the longitude xᵢ, the latitude yᵢ, and the altitude zᵢ, or the slope αᵢ and the cant βᵢ for each of the points Rᵢ constituting the run 12.

In addition, the digital map 140 contains the coordinates of the positions of objects, such as for example a pedestrian crossing 20 of position referenced P1 in FIG. 1.

Where appropriate, the digital map may naturally include the coordinates of the positions of other objects such as traffic lights, a stop sign, or any other type of object.

Preferably, the generator means 120 generate the curve of optimum driving profiles [Popt] also on the basis of a digital model of the bus 160.

This digital model of the bus 160 models the behavior of the bus, in particular its energy consumption, as a function of the run to be followed.

Since the run 12 to be followed is known a priori from the digital map 140, as is the predetermined time for traveling along said run, the generator means 120 are suitable for generating the curve of optimum driving profiles [Popt] that enables the energy consumed by the bus while traveling along the run 12 in a predetermined time to be minimized.

Furthermore, the driving assistance device 100 includes means 180 for determining the current driving profile Pc(t) at the current position R(t) of the bus 10, which means 180 are suitable for acquiring parameters that are intrinsic to the bus 10 at the current position R(t). In the meaning of the present invention, the parameters that are intrinsic to the bus 10 comprise fuel consumption, engine speed, bus speed, engine torque, and the acceleration of the bus at the current position R(t).

These intrinsic parameters are acquired specifically via the multiplexed databus 200 of the bus 10.

Preferably, the intrinsic parameters that are acquired comprise the characteristic magnitudes or they enable them to be calculated.

Furthermore, the driving assistance device 100 includes means 220 for determining an optimum driving profile Popt(t) for the current position R(t) from the curve of optimum driving profiles [Popt].

To do this, said means 220 for determining an optimum driving profile Popt(t) comprise a detector device 240 for detecting the current position R(t) of the vehicle. Specifically, the detector device 240 is a global positioning system of the GPS or GALILEO type that is suitable for providing the position of the bus 10.

Since the current position R(t) is a point on the run 12, said position can be reset by determining a point Rⱼ of the map 140 that corresponds thereto, or at least that is closer thereto than the other points R_{i≠j} of the run 12.

From the curve [Popt], a value Popt (R(t)) is thus determined that optimizes the driving profile for the current position R(t).

Preferably, but not necessarily, said means 220 for determining the optimum driving profile Popt(t) for the current position R(t) further comprise a telemeter 260, e.g. a radar mounted at the front of the bus 10 to detect the presence of obstacles on the run 12, such as for example a truck 22 stopped on the roadway, as shown in FIG. 1.

Furthermore, and preferably, said means 220 for determining the optimum driving profile Popt(t) for the current position R(t) further include sensors 280 for measuring the mass M(t) of the bus 10 at the current position R(t).

This dynamic load, as explained above, is a function in particular of the number of passengers on board the bus 10.

Specifically, the optimum driving profile Popt(t) for the current position R(t) is thus determined from the above-mentioned value Popt(R(t)), the presence of any obstacles, and the mass M(t) of the bus 10.

Preferably, the optimum driving profile Popt(t) also depends on the state of at least one traffic light 17 situated close to the bus 10, and on the length of time remaining before said traffic light changes state.

As can be seen in FIG. 2, the driving assistance device 100 further includes a comparator 300, or any other type of system suitable for performing a comparison function, in order to determine a current difference ε(t) between the optimum driving profile Popt(t) and the current driving profile Pc(t) for the current position R(t). In other words, the following applies:

ε(t)=Popt(t)−Pc(t)

ps This difference ε(t) is non-zero as soon as the current driving profile Pc(t) differs from the optimum driving profile for the current position Popt(t).

Means 320 are advantageously provided for correcting the driving profile of the bus 10 as a function of the difference ε(t) as determined. Specifically, a visual signal representative of the difference ε(t) is delivered to the driver of the bus 10 via a man-machine interface 320, here constituted by three colored lights.

In the example described, the driving profile is the speed V of the bus, such that the difference ε(t) as determined corresponds to the difference between the speed at the current instant Vc(t) and the optimum speed Vopt(t) at which the bus 10 ought to be traveling at said instant t in order to optimize its energy consumption, given the predetermined time for traveling along the run 12.

As can be seen in FIG. 2, the man-machine interface 320 comprises a red light R1, an orange light O1, and a green light V1.

By means of the present invention, when the bus 10 at the current position R(t) presents a speed Vc(t) that is equal to the optimum speed Vopt(t) for said current position, to within some determined speed tolerance depending on the fineness of the display, the difference ε(t) is zero, or is tending towards 0, and the green light V1 of the man-machine interface 320 is the only light that is on, such that the driver of the bus is informed that the bus 10 is running at the optimum speed, to within some speed tolerance.

In contrast, if the bus 10 presents a speed Vc(t) that is faster than the optimum speed Vopt(t) for said current position, then the difference ε(t) is negative and the red light R1 of the man-machine interface 320 is the only light that is on, such that the driver is informed that the bus 10 is traveling at a speed faster than the optimum speed Vopt(t). The driver can then slow down until the green light V1 switches on, meaning that the bus has reached its optimum speed, to within some speed tolerance.

Similarly, if the bus 10 presents a speed Vc(t) that is less than the optimum speed Vopt(t) for said current position, then the difference ε(t) is positive and the orange light 01 of the man-machine interface 320 is the only light on, such that the driver is informed that the bus 10 presents a speed slower than the optimum Vopt(t). The driver can then accelerate until the green light V1 switches on, which means that the bus has reached its optimum speed, to within some speed tolerance.

Without going beyond the ambit of the present invention, other types of man-machine interface can be provided that are suitable for providing the driver with visible or audible information representative of the difference ε(t) as determined.

Advantageously, the generator means 120 further include updating means for calculating a new curve of optimum driving profiles between the current position R(t) of the vehicle and the second point B if the difference ε(t), or its absolute value, exceeds a predetermined threshold.

For example, this difference may become too great as a result of the bus slowing down due to the presence of the obstacle 22 being detected on the run 12.

This calculation takes account of the location of the bus at the instant t, of the dynamic load M(t) at the instant t, and also of intrinsic parameters of the bus, as defined above, and as measured at instant t.

When running is updated, a projection to a position R(t+δt) is made by extrapolating the variation in the current parameters at the position R(t), where δt represents the time needed by the on-board system to calculate a new optimum driving profile while in running condition. This updating then takes account of the values of the parameters V(t), A(t), T(t), Es(t), and Cc(t) at the instant t as provided by the multiplexed databus 200.

In another variant of the invention, the means for correcting the driving profile of the bus 10 as a function of the difference ε(t) as determined, comprise a device for restraining the accelerator pedal of the bus, or in another variant, these means are suitable for providing a control relationship for acting on the control members of the bus 10 so as to modify the driving profile thereof in order to make it correspond with the optimum driving profile.

In another advantageous variant, the assistance device 100 further includes a table of theoretical times 420 suitable for providing a signal Tp(t) relating to the time for traveling along the determined run at instant t. Preferably, the generator means 120 take account of the signal Tp(t) to determine the curve of optimum driving profiles [Popt].

Furthermore, the device also includes a database 440 storing the extent to which the bus 10 is early or late compared with the specified theoretical timetable or travel times. This database 440 is coupled to the timetable 420 so as to reset the travel time Tp(t) while taking account of the extent to which the bus 10 is early/late before transmitting the reset signal to the means 220 for determining an optimum driving profile.

1. A method of assisting the driving of a vehicle for traveling along a run defined between a first point and a second point, wherein there is provided a curve of optimum driving profiles seeking to optimize the energy consumed by the vehicle in order to travel along the run and the time taken to travel along the run, in which method, while the vehicle is traveling, the following steps are performed:
determining a current driving profile at a current position of the vehicle;
determining an optimum driving profile for the current position from the curve of optimum profiles;
determining a difference between the current driving profile and the optimum driving profile for the current position; and
correcting the driving profile of the vehicle as a function of the difference as determined.

2. The driving assistance method according to claim 1, wherein the curve of optimum driving profiles is determined from a digital map of the run.

3. The driving assistance method according to claim 2, wherein the digital map comprises the longitude, the latitude, and the altitude of a plurality of points constituting the run.

4. The driving assistance method according to claim 2, wherein the curve of optimum driving profiles is also determined from the positions of objects having coordinates contained in the digital map of the run.

5. The driving assistance method according to claim 1, wherein the curve of optimum driving profiles is also determined from the running time needed to travel the distance from the first point to the second point as reset relative to the extent the vehicle is early or late relative to its intended arrival time at the second point.

6. The driving assistance method according to claim 1, wherein the current driving profile is determined from parameters intrinsic to the vehicle at the current position, said intrinsic parameters comprising at least one magnitude selected from fuel consumption, engine speed, vehicle speed, engine torque, and acceleration of the vehicle at the current position.

7. The method of assisting the driving of a vehicle according to claim 1, wherein the current position of the vehicle is detected.

8. The driving assistance method according to claim 7, wherein the optimum driving profile for the current position is determined while taking account of the presence of obstacles on the run as detected by telemetry.

9. The driving assistance method according to claim 7, wherein the optimum driving profile for the current position is also determined from the mass of the vehicle at the current position.

10. The driving assistance method according to claim 1, wherein there is provided a new curve of optimum driving profiles between the current position of the vehicle and the second point if the difference determined at the current position is greater than a predetermined threshold.

11. The driving assistance method according to claim 10, wherein the new curve of optimum driving profiles is calculated from parameters intrinsic to the vehicle at the current position, said intrinsic parameters comprising at least one magnitude selected from fuel consumption, engine speed, vehicle speed, engine torque, and vehicle acceleration at the current position.

12. The driving assistance method according to claim 1, wherein at least one of the first and second points corresponds to a stopping point for the vehicle.

13. The driving assistance method according to claim 1, wherein the difference is sent to a man-machine interface in order to provide the driver of the vehicle with a signal representative of the difference.

14. A driving assistance device for a vehicle that is to travel along a defined run between a first point and a second point wherein said device comprises a curve generator for generating a curve of optimum driving profiles seeking to optimize the energy consumed by the vehicle in order to travel along the run and to optimize the time taken to travel along the run, a system for determining a current driving profile at a current position of the vehicle, a system for determining an optimum driving profile for the current position from the curve of optimum profiles, a comparator for determining a difference between the current driving profile and the optimum driving profile for the current position, and means for correcting the driving profile of the vehicle as a function of the difference as determined.

15. The driving assistance device according to claim 14, wherein the curve generator includes a digital map of the run.

16. The driving assistance device according to claim 15, wherein the digital map comprises the longitude, the latitude, and the altitude of a plurality of points making up the run.

17. The driving assistance device according to claim 15 wherein the digital map further comprises the coordinates of the positions of objects also used by the curve generator for generating the curve of optimum driving profiles.

18. The driving assistance device according to claim 14, wherein the system for determining the current driving profile is suitable for acquiring parameters intrinsic to the vehicle at the current position, said intrinsic parameters comprising at least one magnitude selected from fuel consumption, engine speed, speed and acceleration of the vehicle at the current position, and vehicle mass.

19. The driving assistance device according to claim 14, wherein it further comprises a detector device for determining the current position of the vehicle.

20. The driving assistance device according to claim 14, wherein the system for determining the optimum driving profile for the current position further comprise distance measuring means for detecting the presence of obstacles on the run.

21. The driving assistance device according to claim 14, wherein the system for determining the optimum driving profile for the current position further comprise sensors for measuring the mass of the vehicle at the current position.

22. The driving assistance device according to claim 14, wherein it further includes an updating system for calculating a new curve of optimum driving profiles between the current position of the vehicle and the second point if the difference is greater than a predetermined threshold.

23. The driving assistance device according to claim 22, wherein the updating system is suitable for acquiring parameters intrinsic to the vehicle at the current position, said intrinsic parameters comprising at least one magnitude selected from fuel consumption, engine torque, engine speed, and the speed and the acceleration of the vehicle at the current position (R(t)).

24. The driving assistance device according to claim 14, wherein at least one of the first and second points corresponds to a stopping point for the vehicle.

25. The driving assistance device according to claim 14, wherein the system for correcting the driving profile of the vehicle as a function of the difference as determined, further comprises a man-machine interface for providing the driver of the vehicle with a signal representative of the difference.
